(19) United States
(12) Patent Application Publication
(10) Pub. No.: US 2026/0366475 A1
(43) Pub. Date: Nov. 19, 2026

(54) VAPOR SEPARATOR TANK

(71) Applicant: MIKUNI CORPORATION, Tokyo (JP)

(72) Inventor: Takumi Oikawa, Odawara-shi (JP)

(21) Appl. No.: 19/647,127

(22) Filed: Apr. 14, 2026

(30) Foreign Application Priority Data
May 15, 2025 (JP) 2025-082113

(51) Int. Cl. F02M 37/22; F02M 37/00; F02M 37/08

(52) U.S. Cl. CPC F02M 37/22; F02M 37/0041; F02M 37/08

(57) ABSTRACT

The vapor separator tank includes a casing in which a fuel storage chamber that stores liquid fuel is formed, a pump that pressure-feeds the liquid fuel stored in the fuel storage chamber, and a spacer (i.e., support member) formed of an elastic body and attached to the casing to support the pump. The spacer includes a bottom plate portion that supports a bottom face of the pump, and an upstanding wall portion extending upward from the peripheral edge portion of the bottom plate portion so as to partially surround an outer tube portion of the pump, the outer tube portion being lightly press-fitted into the upstanding wall portion.

### BACKGROUND OF THE INVENTION

### Field of the Invention

The present invention relates to a vapor separator tank having a pump that pressure-feeds liquid fuel stored in a fuel storage chamber.

### Description of the Related Art

Conventionally, there has been known a technology related to a vapor separator tank having a gas-liquid separation function of separating gas, such as evaporated gas and bubbles generated from liquid fuel, and having a pump that pressure-feeds liquid fuel stored in a fuel storage chamber. For example, Japanese Patent Laid-Open No. 2011-073630 describes a vapor separator tank with a structure in which the bottom portion of a high-pressure fuel pump is supported by a lower case via cushion rubber, and the upper portion of the high-pressure fuel pump is supported by an upper case via a rubber bushing.

In the structure described in Japanese Patent Laid-Open No. 2011-073630, axial vibration isolation for the pump can be achieved by providing cushion rubber between the pump and the lower case. However, it is difficult to sufficiently absorb forces or vibrations acting in the radial direction of the pump. Further, when the pump is inserted into and attached to the lower case, the cushion rubber may fall off from the bottom portion of the pump, which makes the assembly work for the vapor separator tank troublesome.

The present invention has been made in view of the foregoing problems, and an object of the present invention is to provide a vapor separator tank capable of improving the vibration isolation performance of a pump, stabilizing the posture of the pump, and facilitating the operation of attaching the pump to a casing, with a simple structure.

### SUMMARY OF THE INVENTION

To achieve the foregoing object, a vapor separator tank of the present invention is a vapor separator tank for separating gas from liquid fuel to be supplied to an internal combustion engine, the vapor separator tank including a casing in which a fuel storage chamber that stores the liquid fuel is formed; a pump that pressure-feeds the liquid fuel stored in the fuel storage chamber; and a support member formed of an elastic body, the support member being attached to the casing to support the pump, in which the support member includes a bottom plate portion that supports a bottom face of the pump, and an upstanding wall portion extending upward from a peripheral edge portion of the bottom plate portion so as to partially surround an outer tube portion of the pump, the outer tube portion being lightly press-fitted into the upstanding wall portion.

The pump may include a protruding portion protruding from the bottom face, and the bottom plate portion of the support member may have a holding recess portion formed therein, the protruding portion being press-fitted into the holding recess portion.

The pump may include a housing space near the bottom face, the housing space housing a rotatable impeller, and the upstanding wall portion may extend to a height that at least partially surrounds the housing space.

The support member may include a fitting protruding portion protruding downward from a lower face of the bottom plate portion, and the casing may include a bowl-shaped recess portion in which the support is arranged, and a fitting recess portion which is formed in a bottom face of the bowl-shaped recess portion and into which the fitting protruding portion is fitted.

According to the vapor separator tank of the present invention, it is possible to improve the vibration isolation performance of a pump, stabilize the posture of the pump, and facilitate the operation of attaching the pump to a casing, with a simple structure.

### BRIEF DESCRIPTION OF THE DRAWINGS

FIG. 1 is a schematic perspective view of a vapor separator tank;

FIG. 2 is a longitudinal sectional view of the vapor separator tank in the XZ plane along line A-A of FIG. 1;

FIG. 3 is a perspective view of the interior of a lower case;

FIG. 4 is a perspective view of a case-side support portion;

FIG. 5 is a perspective view of an upper case, which has a pump and a spacer attached thereto, as seen from diagonally below;

FIG. 6 is an exploded perspective view of the pump and the spacer as seen from diagonally below;

FIG. 7 is an exploded perspective view of the pump and the spacer as seen from diagonally above;

FIG. 8 is a plan view of the spacer; and

FIG. 9 is an enlarged sectional view of a region around the pump and the spacer in FIG. 2.

### DETAILED DESCRIPTION OF THE INVENTION

Hereinafter, an embodiment of the present invention will be described based on the drawings. In the following description, the vertical direction shall be referred to as the "Z-direction," one horizontal direction perpendicular to the "Z-direction" shall be referred to as the "X-direction," and a direction perpendicular to both the X-direction and the Z-direction shall be referred to as the "Y-direction," as appropriate.

### Vapor separator tank

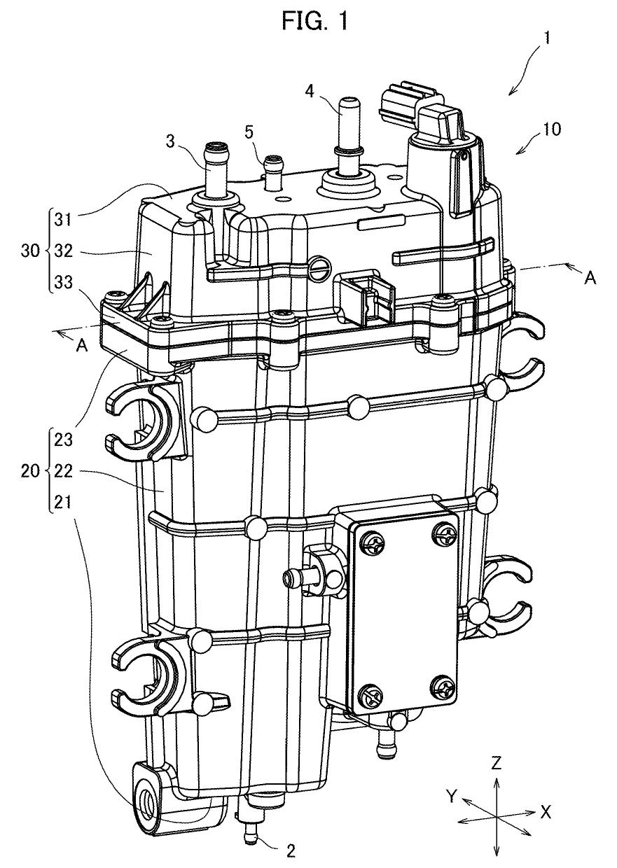

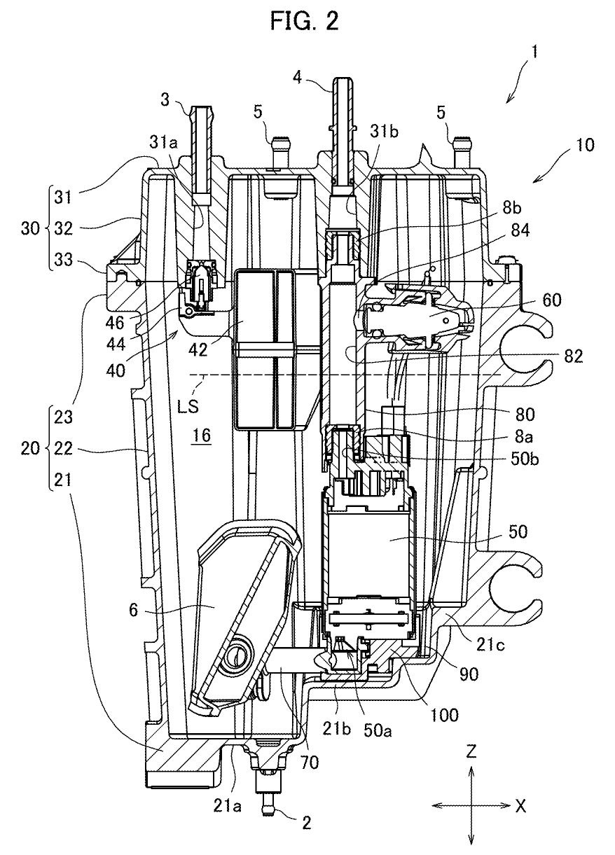

FIG. 1 is a schematic perspective view of a vapor separator tank. FIG. 2 is a longitudinal sectional view of the vapor separator tank in the XZ plane along line A-A of FIG. 1. A vapor separator tank 1 (hereinafter referred to as "VST 1") is applied to an outboard motor (not illustrated) mounted on a vessel, for example. The VST 1 is connected between an internal combustion engine serving as a power source of the outboard motor and a fuel tank for storing liquid fuel, and has a function of temporarily storing liquid fuel to be supplied to the internal combustion engine, and a gas-liquid separation function of separating gas, such as evaporated gas and bubbles generated from the liquid fuel. As illustrated in FIG. 2, the VST 1 includes a casing 10, which includes a lower case 20 and an upper case 30, a float mechanism 40, a pump 50, and a pressure regulator 60.

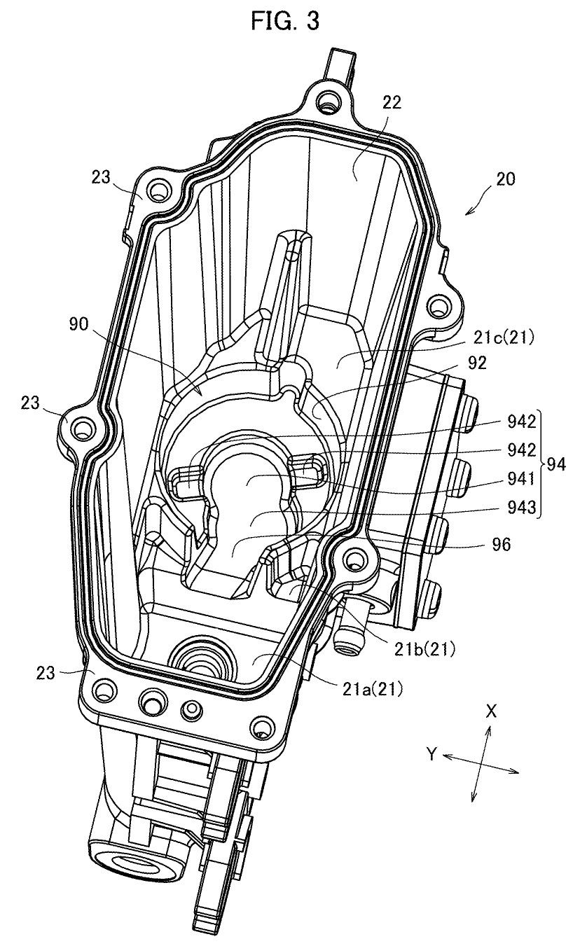

FIG. 3 is a perspective view of the interior of the lower case 20. As illustrated in FIGS. 1-3, the lower case 20 is a container-shaped member that includes a bottom face portion 21, a side wall portion 22 extending upward from the bottom face portion 21, and a fastening face portion 23 projecting outward from the upper end of the side wall portion 22, and has an open upper portion. A space enclosed by the bottom face portion 21 and the side wall portion 22 of the lower case 20 corresponds to a fuel storage chamber 16 (FIG. 2) for storing liquid fuel.

The bottom face portion 21 of the lower case 20 is provided with a case-side support portion 90 for supporting the pump 50 via a spacer (i.e., support member) 100 described later. In addition, the lower portion of the lower case 20 is provided with a drain pipe 2 for discharging fuel from the fuel storage chamber 16 during maintenance or when the internal combustion engine is not used for a long period during off-season.

The upper case 30 is a cover member that closes the open upper portion of the lower case 20. The upper case 30 includes a ceiling portion 31, a side wall portion 32 extending downward from the ceiling portion 31, and a fastening face portion 33 projecting outward from the lower end of the side wall portion 32. The lower case 20 and the upper case 30 abut each other at their fastening face portions 23 and 33, and are fastened together with a plurality of fasteners.

The ceiling portion 31 is provided with a fuel inlet passage 31a connected to a fuel tank, which is arranged outside the VST 1, via an inlet pipe 3. Liquid fuel from the fuel tank is pressure-fed and supplied to the fuel inlet passage 31a by a pump (not illustrated). In addition, the ceiling portion 31 is provided with a fuel outlet passage 31b connected to a discharge port 50b of the pump 50. The fuel outlet passage 31b is connected to a pipe on the side of the internal combustion engine, which is arranged downstream of the VST 1, via an outlet pipe 4. Further, the ceiling portion 31 is provided with two air vent pipes 5 for discharging vaporized fuel, such as evaporated fuel and bubbles from the liquid fuel, to the outside. Note that the VST 1 may be a sealed vapor separator tank that has no air vent pipe, and liquefies gas using the pump 50.

The float mechanism 40 includes a float 42, a hinge 44, and a valve 46. The float 42 is pivotally supported by the upper case 30 via the hinge 44, and floats on the liquid fuel within the fuel storage chamber 16. The float 42 moves in response to the rise and fall of a liquid surface LS, indicated by a dashed line in FIG. 2, of the liquid fuel. The hinge 44 is structured to move vertically together with the valve 46 provided in the fuel inlet passage 31a.

Accordingly, when the liquid fuel level in the fuel storage chamber 16 is below a predetermined reference value, the float 42 falls below a predetermined location. Thus, the hinge 44 pushes down a valve element of the valve 46, thereby opening the valve 46. Consequently, liquid fuel flows into the fuel storage chamber 16 from the fuel inlet passage 31a. Meanwhile, when the liquid fuel level in the fuel storage chamber 16 is at or above the reference value, the float 42 attempts to rise above the predetermined position. Thus, the hinge 44 pushes up the valve element of the valve 46, thereby closing the valve 46. Consequently, the inflow of liquid fuel into the fuel storage chamber 16 from the fuel inlet passage 31a is restricted. Thus, the liquid fuel level in the fuel storage chamber 16 is regulated to be constant. Note that the VST 1 may not include the float mechanism 40, and in such a case, the amount of liquid fuel stored in the fuel storage chamber 16 may be regulated using a pump arranged outside.

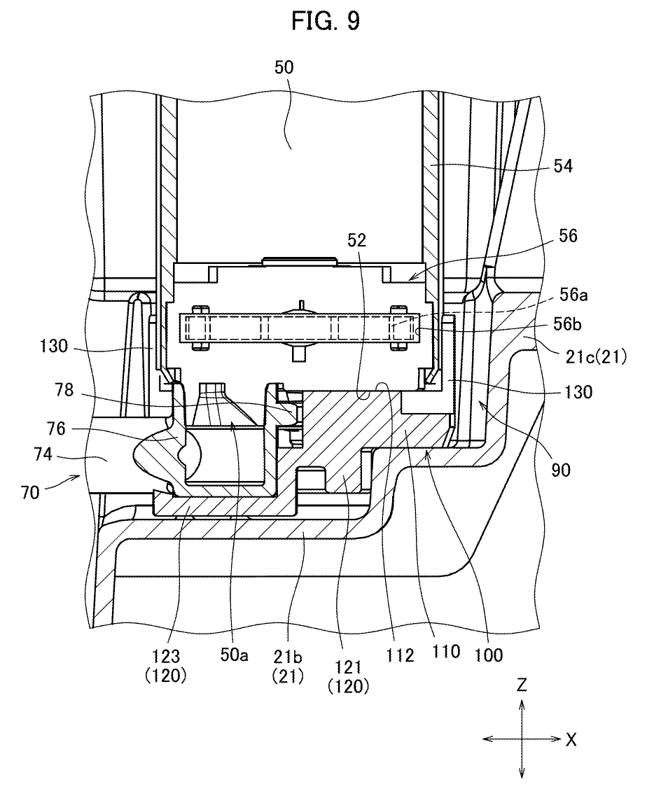

The pump 50 is a pump, housed within the casing 10, for pressure-feeding liquid fuel stored in the fuel storage chamber 16. The pump 50 is arranged vertically in the fuel storage chamber 16 such that the direction of the rotation axis of an impeller 56a (i.e., dashed lines in FIG. 9) aligns with the vertical direction. A suction port 50a of the pump 50 has connected thereto a filter 6 for filtering liquid fuel and a suction pipe 70. The pump 50 suctions the liquid fuel in the fuel storage chamber 16 via the filter 6 and the suction pipe 70.

Meanwhile, the discharge port 50b of the pump 50 has a joint member 80 attached thereto via a bushing 8a formed of an elastic body. The joint member 80 is a hollow cylindrical member extending along the axial direction of the pump 50, and includes a discharge flow path 82 formed therein and communicating with the discharge port 50b. The upper end portion of the joint member 80 is fitted into the inner peripheral surface of the fuel outlet passage 31b via a bushing 8b formed of an elastic body. The fuel outlet passage 31b has the outlet pipe 4 connected thereto. Liquid fuel discharged from the pump 50 is pressure-fed to a pipe (not illustrated) arranged outside the VST 1 (on the internal combustion engine side) via the discharge flow path 82, the fuel outlet passage 31b, and the outlet pipe 4.

The pressure regulator 60 is connected to a midway portion of the discharge flow path 82 of the joint member 80 via a relief flow path 84. The pressure regulator 60 includes, within its substantially cylindrical case, a valve element, a valve seat portion, and a spring (which are not illustrated), for example, and opens in response to an increase in the pressure of fuel flowing into the relief flow path 84, and then returns excess fuel back to the fuel storage chamber 16. Accordingly, the discharge pressure of the pump 50, that is, the pressure of liquid fuel to be supplied to the internal combustion engine is regulated to be constant.

### Support structure for pump

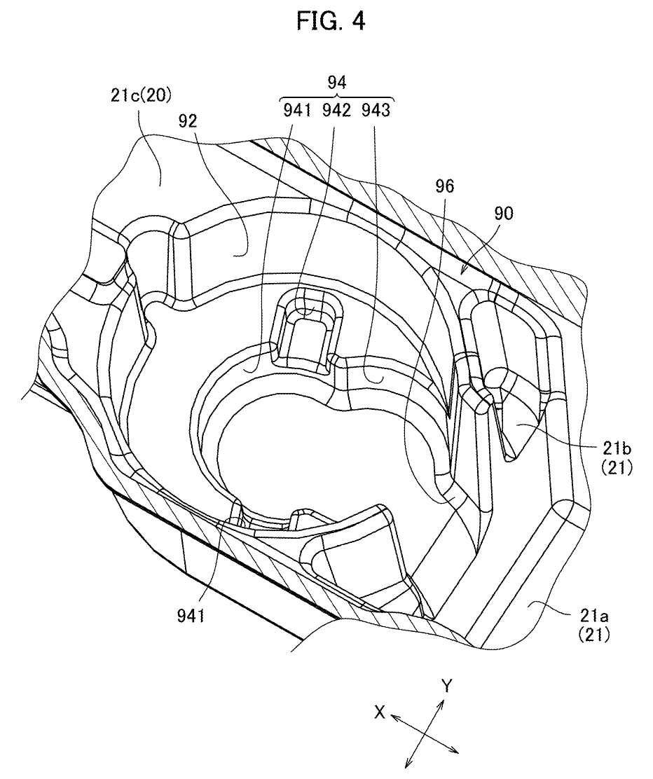

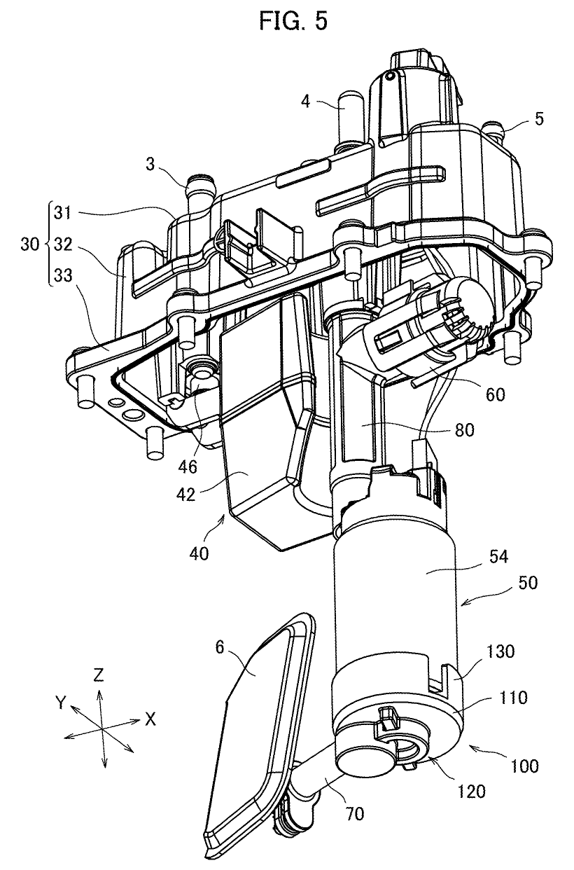

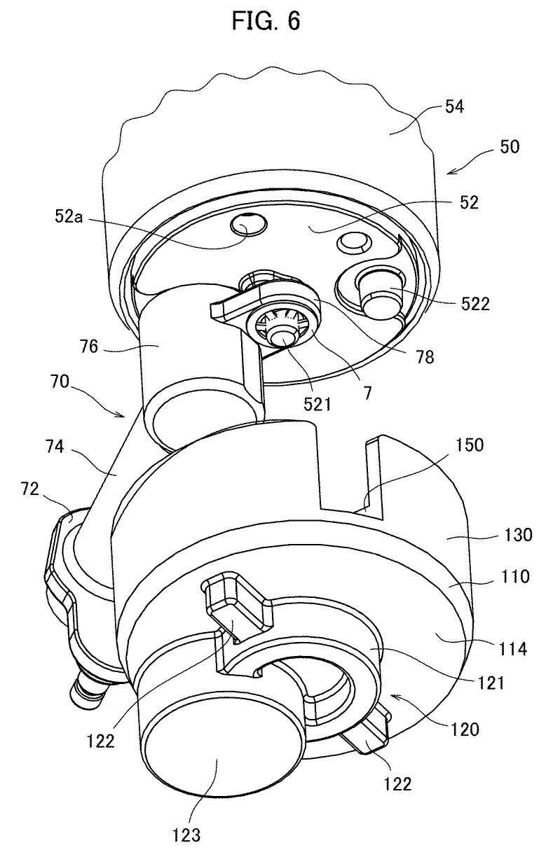

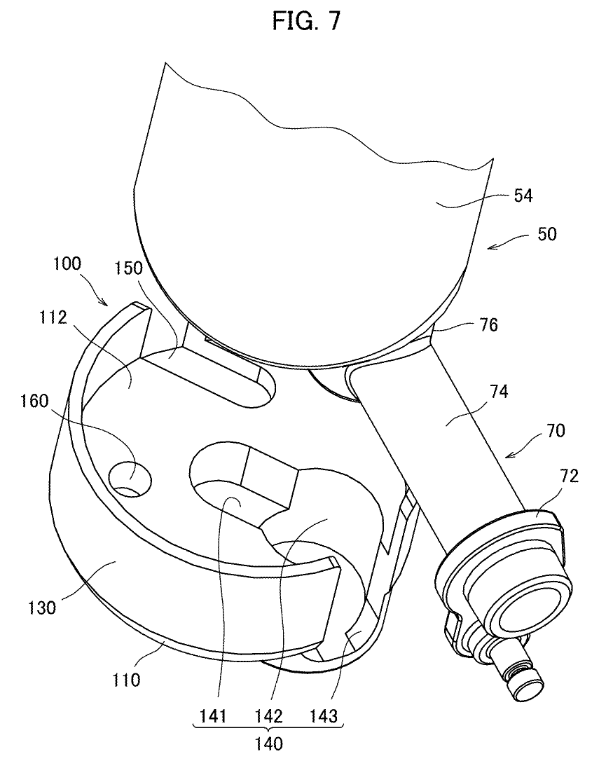

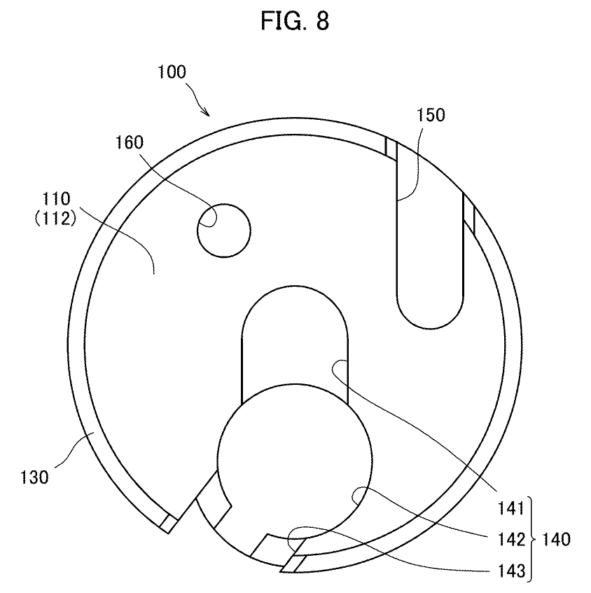

Next, a support structure for the pump 50 will be described. FIG. 4 is a perspective view of the case-side support portion. FIG. 5 is a perspective view of the upper case 30, which has the pump 50 and a spacer 100 attached thereto, as seen from diagonally below. FIG. 6 is an exploded perspective view of the pump 50 and the spacer 100 as seen from diagonally below. FIG. 7 is an exploded perspective view of the pump 50 and the spacer 100 as seen from diagonally above. FIG. 8 is a plan view of the spacer 100. FIG. 9 is an enlarged sectional view of a region around the pump 50 and the spacer 100 in FIG. 2.

### Case-side support portion

First, the case-side support portion 90 formed on the bottom face portion 21 of the lower case 20 will be described. As illustrated in FIGS. 2-4, the bottom face portion 21 includes a first bottom face portion 21a, a second bottom face portion 21b located above the first bottom face portion 21a, and a third bottom face portion 21c located above the second bottom face portion 21b. The case-side support portion 90 is provided between the second bottom face portion 21b and the third bottom face portion 21c, and includes a bowl-shaped recess portion 92, a fitting recess portion 94, and a groove portion 96.

As illustrated in FIG. 4, the bowl-shaped recess portion 92 is a recess portion that is recessed downward from the third bottom face portion 21c to form a bowl shape. The inside diameter of the bowl-shaped recess portion 92 is set slightly larger than the outside diameter of the spacer 100. The fitting recess portion 94 is a recess portion that is recessed further downward from the bottom face of the bowl-shaped recess portion 92. The fitting recess portion 94 includes a first fitting recess portion 941, a pair of second fitting recess portions 942, and a third fitting recess portion 943. The first fitting recess portion 941 is a recess portion that is recessed at the center of the fitting recess portion 94 to form a substantial bowl shape. The pair of second fitting recess portions 942 are recess portions each extending laterally in a rectangular shape from the first fitting recess portion 941. The third fitting recess portion 943 is a recess portion that is provided adjacent to the first fitting recess portion 941, and is recessed to form a bowl shape. The third fitting recess portion 943 is formed to be continuous with a midway portion of the first fitting recess portion 941. In addition, the groove portion 96 extends from the third fitting recess portion 943 in the X-direction toward the first bottom face portion 21a. The groove portion 96 is provided to penetrate the bowl-shaped recess portion 92, and serves as a portion for passing a circular pipe portion 74 of the suction pipe 70 described later.

### Spacer

As illustrated in FIGS. 5-9, the spacer 100 is attached to the lower end portion of the pump 50 to be interposed between the pump 50 and the case-side support portion 90. The spacer 100 is a bowl-shaped (i.e., bottom-closed tubular) member formed of an elastic body, such as a polymer material like rubber, for example. More specifically, the spacer 100 includes a disc-like bottom plate portion 110, a fitting protruding portion 120, and an upstanding wall portion 130 extending perpendicularly upward from the peripheral edge of the bottom plate portion 110.

The bottom plate portion 110 includes an upper face 112 that abuts a bottom face 52 of the pump 50 to support the pump 50, and a lower face 114 located on the opposite side of the upper face 112. As illustrated in FIG. 6, the lower face 114 of the bottom plate portion 110 is provided with the fitting protruding portion 120 to be fitted into the fitting recess portion 94 of the case-side support portion 90.

The fitting protruding portion 120 includes a first fitting protruding portion 121 protruding substantially annularly from the lower face 114, a pair of second fitting protruding portions 122 each extending laterally in a rectangular shape from the first fitting protruding portion 121, and a third fitting protruding portion 123 that is cylindrical in shape and is adjacent to the first fitting protruding portion 121. The spacer 100 is arranged on the inner side of the bowl-shaped recess portion 92 of the case-side support portion 90, and is detachably attached to the lower case 20 as the first fitting protruding portion 121 is fitted into the first fitting recess portion 941, the second fitting protruding portions 122 are fitted into the second fitting recess portions 942, and the third fitting protruding portion 123 is fitted into the third fitting recess portion 943. Note that the spacer 100 may be fitted into the inner peripheral surface of the bowl-shaped recess portion 92.

The upstanding wall portion 130 is an annular protruding portion formed to surround a part of an outer tube portion 54 of the pump 50 near its bottom face 52. The upstanding wall portion 130 is formed to have a diameter that allows the outer tube portion 54 to be lightly press-fitted into the inner peripheral surface of the upstanding wall portion 130. As illustrated in FIG. 9, a pumping mechanism 56 for pressure-feeding liquid fuel is arranged near the bottom face 52 inside the pump 50. The pumping mechanism 56 includes the impeller 56a (see the dashed lines) for pushing liquid fuel upward through rotation. The impeller 56a is rotatably arranged within a housing space 56b of the pumping mechanism 56. The upstanding wall portion 130 extends to a height that at least partially surrounds the housing space 56b. This allows the upstanding wall portion 130 to absorb forces and vibrations acting in the radial direction of the pump 50. In addition, as the outer tube portion 54 is lightly press-fitted into the inner peripheral surface of the upstanding wall portion 130, it becomes easier for the spacer 100 to be held at the lower end portion of the pump 50.

The upper face 112 of the spacer 100 has a positioning groove portion 140 for receiving the suction pipe 70 formed therein. As illustrated in FIG. 6, the suction pipe 70 of this embodiment includes a tip portion 72 to which the filter 6 (FIGS. 2 and 5) is attached, the circular pipe portion 74 extending from the tip portion 72, a cylindrical portion 76 communicating with both the circular pipe portion 74 and the suction port 50a (FIGS. 2 and 9) of the pump 50, and an attachment portion 78 extending from the cylindrical portion 76. The attachment portion 78 extends from the cylindrical portion 76 along the bottom face 52 of the pump 50, and a first protruding portion 521 protruding from the bottom face 52 passes through the attachment portion 78. Note that a fixture 7 is arranged around the first protruding portion 521.

In contrast, as illustrated in FIGS. 7 and 8, the positioning groove portion 140 includes a first groove portion 141, a second groove portion 142, and a third groove portion 143. The first groove portion 141 is formed in a shape generally conforming to the attachment portion 78 of the suction pipe 70. The second groove portion 142 is a recess portion connected to an end portion of the first groove portion 141, and is formed in a shape generally conforming to the cylindrical portion 76 of the suction pipe 70. The third groove portion 143 extends from the second groove portion 142 to an end face of the spacer 100, and is provided to penetrate the upstanding wall portion 130. The third groove portion 143 has a shape generally conforming to the outer peripheral surface of the circular pipe portion 74 of the suction pipe 70. The second groove portion 142 and the third groove portion 143 are provided in the foregoing third fitting protruding portion 123.

Such a configuration allows the pump 50 and the suction pipe 70 to be positioned circumferentially relative to the spacer 100 as the attachment portion 78 of the suction pipe 70 is inserted into the first groove portion 141, the cylindrical portion 76 is inserted into the second groove portion 142, and the circular pipe portion 74 is inserted into the third groove portion 143. Note that the positioning groove portion 140 need only abut the suction pipe 70 sufficiently to enable the foregoing positioning, and the suction pipe 70 may be detachably press-fitted into the positioning groove portion 140.

The upper face 112 also has a relief groove portion 150 formed therein to communicate with a vapor discharge port 52a (FIG. 6) formed in the bottom face 52 of the pump 50. The relief groove portion 150 is formed at a position where it overlaps the vapor discharge port 52a in the axial direction of the pump 50 in a state where the pump 50 is positioned relative to the spacer 100. The relief groove portion 150 extends to an end face of the spacer 100, and penetrates the upstanding wall portion 130. This allows vapor discharged through the vapor discharge port 52a to be discharged to the outer side of the spacer 100 via the relief groove portion 150.

Further, as illustrated in FIGS. 7 and 8, the upper face 112 has a holding recess portion 160 for holding the pump 50 relative to the spacer 100 formed therein. In this embodiment, as illustrated in FIG. 6, the bottom face 52 of the pump 50 has a second protruding portion (i.e., protruding portion) 522 protruding in a cylindrical shape toward the spacer 100 formed thereon. The holding recess portion 160 is a recess portion that is provided at a position where it overlaps the second protruding portion 522 in the axial direction of the pump 50 in a state where the pump 50 is positioned relative to the spacer 100, and is recessed such that it has a circular cross-section. The holding recess portion 160 is formed to have a diameter that allows the second protruding portion 522 to be press-fitted into the inner peripheral surface of the holding recess portion 160. The second protruding portion 522 is press-fitted into the holding recess portion 160 with a force greater than that required when the outer tube portion 54 is lightly press-fitted into the inner peripheral surface of the upstanding wall portion 130. This allows the spacer 100 to be held at the lower end portion of the pump 50 further stably.

### Advantageous effects of embodiment

As described above, the VST 1 of the embodiment includes the casing 10 in which the fuel storage chamber 16 that stores liquid fuel is formed, the pump 50 that pressure-feeds the liquid fuel stored in the fuel storage chamber 16, and the spacer (i.e., support member) 100 that is formed of an elastic body and is attached to the casing 10 to support the pump 50. The spacer 100 includes the bottom plate portion 110 that supports the bottom face 52 of the pump 50, and the upstanding wall portion 130 extending upward from the peripheral edge portion of the bottom plate portion 110 so as to partially surround the outer tube portion 54 of the pump 50, the outer tube portion 54 being lightly press-fitted into the upstanding wall portion 130.

Such a configuration allows the upstanding wall portion 130 to absorb forces and vibrations acting on the pump 50 in the radial direction, as described above. It is also possible to suppress the occurrence of oscillation (i.e., tilting) of the pump 50 originating from the connection portion of the upper end portion of the pump 50 (i.e., the upper end portion of the joint member 80) and the upper case 30, which is associated with radial vibrations. This can improve the radial vibration isolation performance of the pump 50 and stabilize the posture of the pump 50. Further, by providing the upstanding wall portion 130 on the spacer 100, which has been conventionally used to support the pump 50 and achieve axial vibration isolation for the pump 50, there is no need to use any dedicated components other than the spacer 100 to improve the radial vibration isolation performance of the pump 50 and stabilize the posture of the pump 50. Thus, the number of components can be reduced.

Further, as the outer tube portion 54 is lightly press-fitted into the upstanding wall portion 130, it becomes easier for the pump 50 to hold the spacer 100 than when the upstanding wall portion 130 is not provided. Therefore, as illustrated in FIG. 5, for example, when components, such as the pump 50 and the spacer 100, are lifted while being attached to the upper case 30, the spacer 100 is less likely to fall off from the pump 50 than when the upstanding wall portion 130 is not provided. This improves workability when such components are inserted into the interior of the lower case 20. As described above, according to the VST 1 of the embodiment, it is possible to improve the vibration isolation performance of the pump 50, stabilize the posture of the pump 50, and facilitate the operation of attaching the pump 50 to the casing 10, with a simple structure.

The pump 50 includes the second protruding portion (i.e., protruding portion) 522 protruding from the bottom face 52, and the bottom plate portion 110 of the spacer 100 has the holding recess portion 160 formed therein, the second protruding portion 522 being press-fitted into the holding recess portion 160. Such a configuration allows the pump 50 to hold the spacer 100 more firmly, thereby more favorably suppressing falling-off of the spacer 100 from the pump 50. Note that the light press-fitting of the pump 50 into the upstanding wall portion 130, and the press-fitting of the second protruding portion 522 into the holding recess portion 160 are performed to allow an operator to manually detach the spacer 100 from the pump 50.

The pump 50 is provided with the housing space 56b, which houses the rotatable impeller 56a, near the bottom face 52, and the upstanding wall portion 130 extends to a height that at least partially surrounds the housing space 56b. Such a configuration allows the upstanding wall portion 130 to surround a sufficient length of the outer tube portion 54, thereby improving the vibration isolation performance of the pump 50, stabilizing the posture of the pump 50, and stably holding the spacer 100. In particular, providing the upstanding wall portion 130 up to a position close to the impeller 56a, which is prone to vibration, makes it possible to further improve the vibration isolation performance of the pump 50.

The spacer 100 includes the fitting protruding portion 120 protruding downward from the lower face 114 of the bottom plate portion 110, and the casing 10 includes the bowl-shaped recess portion 92 in which the spacer 100 is arranged, and the fitting recess portion 94 which is formed in the bottom face of the bowl-shaped recess portion 92 and into which the fitting protruding portion 120 is fitted. Such a configuration allows the casing 10 to stably support the spacer 100, thereby improving the vibration isolation performance of the pump 50.

An embodiment has been described above, but the aspects of the present invention are not limited thereto. For example, this embodiment applies a structure in which the spacer 100 is used for the VST 1 having a single pump 50 to support the pump 50. Note that the support structure for the pump of this embodiment may also be applied to a vapor separator tank having a plurality of pumps. In such a case, the spacer 100 may be attached to the lower end portion of each pump.

The upstanding wall portion 130 of the spacer 100 need only surround the outer tube portion 54 of the pump 50 at least partially as long as it can improve the vibration isolation performance of the pump 50, stabilize the posture of the pump 50, and suppress falling-off of the spacer 100 from the pump 50.

### REFERENCE SIGNS LIST

1 vapor separator tank (VST)
10 casing
16 fuel storage chamber
20 lower case
21 bottom face portion
30 upper case
40 float mechanism
50 pump
52 bottom face
522 second protruding portion (i.e., protruding portion)
54 outer tube portion
56 pumping mechanism
56a impeller
56b housing space
60 pressure regulator
90 case-side support portion
92 bowl-shaped recess portion
94 fitting recess portion
100 spacer (i.e., support member)
110 bottom plate portion
120 fitting protruding portion
130 upstanding wall portion
160 holding recess portion

What is claimed is:

1. A vapor separator tank for separating gas from liquid fuel to be supplied to an internal combustion engine, the vapor separator tank comprising:
a casing in which a fuel storage chamber that stores the liquid fuel is formed;
a pump that pressure-feeds the liquid fuel stored in the fuel storage chamber; and
a support member formed of an elastic body, the support member being attached to the casing to support the pump,
wherein:
the support member includes a bottom plate portion that supports a bottom face of the pump, and an upstanding wall portion extending upward from a peripheral edge portion of the bottom plate portion so as to partially surround an outer tube portion of the pump, the outer tube portion being lightly press-fitted into the upstanding wall portion.

2. The vapor separator tank according to claim 1,
wherein:
the pump includes a protruding portion protruding from the bottom face, and
the bottom plate portion of the support member has a holding recess portion formed therein, the protruding portion being press-fitted into the holding recess portion.

3. The vapor separator tank according to claim 1,
wherein:
the pump includes a housing space near the bottom face, the housing space housing a rotatable impeller, and
the upstanding wall portion extends to a height that at least partially surrounds the housing space.

4. The vapor separator tank according to claim 1,
wherein:
the support member includes a fitting protruding portion protruding downward from a lower face of the bottom plate portion, and
the casing includes a bowl-shaped recess portion in which the support member is arranged, and a fitting recess portion which is formed in a bottom face of the bowl-shaped recess portion and into which the fitting protruding portion is fitted.

5. The vapor separator tank according to claim 2,
wherein:
the pump includes a housing space near the bottom face, the housing space housing a rotatable impeller, and
the upstanding wall portion extends to a height that at least partially surrounds the housing space.

6. The vapor separator tank according to claim 2,
wherein:
the support member includes a fitting protruding portion protruding downward from a lower face of the bottom plate portion, and
the casing includes a bowl-shaped recess portion in which the support member is arranged, and a fitting recess portion which is formed in a bottom face of the bowl-shaped recess portion and into which the fitting protruding portion is fitted.
